(19) United States
(12) Patent Application Publication
(10) Pub. No.: US 2003/0061128 A1
(43) Pub. Date: Mar. 27, 2003

(54) Inventory management system for estimating supply by incorporating reparable products into future production

(75) Inventors: Li-Kuei Lin, Taipei (TW); Jih-Hong Huang, Taipei (TW)

Correspondence Address: BACON & THOMAS, PLLC, 625 SLATERS LANE, FOURTH FLOOR, ALEXANDRIA, VA, 22314

(73) Assignee: Inventec Corporation

(21) Appl. No.: 09/962,321

(22) Filed: Sep. 26, 2001

(51) Int. Cl. G06F 17/60

(52) U.S. Cl. 705/29

(57) ABSTRACT

An inventory management system having a network connection interconnected computers of a product manufacturer and at least one buyer, wherein a process proceeded by the computer of product manufacturer having a database installed therein comprising the steps of estimating a quantity of repairable products based on records of a returned ratio, a repaired ratio and an inventory of returned products stored in the database and combining the estimated quantity of repairable products with an estimated quantity of products regularly ordered by the buyer and an inventory of the products stored in the database to estimate a supply quantity of the products of a forthcoming period of time.

### FIELD OF THE INVENTION

The present invention relates to inventory management system and more particularly to such an inventory management system for estimating supply by incorporating reparable products into future production.

### BACKGROUND OF THE INVENTION

Information technologies have known a rapid and a spectacular development in decades. And in turn competition has become even fierce in all fields. Also, an increasing use of telecommunications and the convenience of transportation have expanded global commerce and trade significantly. In view of this, almost all well known product manufacturers endeavor to research and analyze resources of manpower, capitals, technologies, and distribution in the world. Thereafter, it is possible of utilizing characteristics and advantages associated with various regions in the world for establishing branches of research and development, manufacturing, and trade therein. In one aspect, the research and development branch can tailor the needs of local market to design appropriate products. Moreover, the manufacturing branch may produce the same. Finally, the produced products may be delivered to the consumers through associated distributors in the world. This process can significantly reduce cost and delivery time as well as enhance competition.

As stated above, almost all well known product manufacturers endeavor to integrate their design, development, manufacturing, and marketing in their global strategy. In addition, the research and development branch is required to tailor the needs of local market to design appropriate products. Finally, the manufactured products may be quickly delivered to the consumers through associated distributors in the world. As to the product manufacturers, they have to increase information communication efficiency thereof so as to cooperate with associated manufacturers. Also, the communication should be efficient and accurate. With this, it is possible of truly reflecting markets, quickly delivering goods, and minimizing inventory. As an end, the purposes of attracting consumers with such products and being competitive in the markets are obtained.

Generally speaking, a mechanism for estimating future needs is established among buyers, products manufacturers, and component part suppliers under above manufacturing mode wherein a network connection is utilized to interconnect computer systems among buyers, product manufacturers and component part suppliers. This establishes a communication channel among them. As such, product manufacturer may estimate quantity of component parts demanded by buyers (by estimation also) in a forthcoming period of time. Thereafter, component part suppliers may be informed of the quantity of estimated component parts by product manufacturer. Hence, component part suppliers can estimate possible quantity of supplied component parts based on inventory and a possible future production thereof during the prescribed period of time. Also, product manufacturer can reliably estimate a future production by taking the precisely estimated quantity of possibly produced component parts by component part suppliers into consideration. This can minimize inventory of both component part suppliers and product manufacturer. Additionally, product manufacturer can take this estimation as a basis for accepting orders from buyers. Eventually, after ordering buyer may be assured of obtaining the desired goods from product manufacturer after the prescribed period of time.

Conventionally, buyer may regularly inform product manufacturer both of an estimated future supply based on market and an estimation of possible returned products in a forthcoming period of time. Hence, product manufacturer may supply the same quantity of products as that of returned products to buyer in time. However, information about such returned products is not sent to database of the current inventory management system for processing. Hence, there is no way for the system to know the quantity of repaired products for updating inventory of product manufacturer. As a result, there is an inconsistency (sometimes significant) between actual inventory and shown inventory in database with respect to products. This can increase inventory and associated cost. Also, information provided by the inventory management system is not reliable. In response, product manufacturer usually instructs employees to check inventory manually and input data about repaired products into database. This is time and labor consuming. Further, a potential error in above manual checking and/or input may adversely affect the accuracy of inventory. This in turn brings a number of disadvantages such as excessive products, etc.

Thus, it is desirable to provide an improved inventory management system for precisely estimating future demand by incorporating reparable products into future production in order to overcome the above drawbacks of prior art.

### SUMMARY OF THE INVENTION

It is therefore an object of the present invention to provide an inventory management system having a network connection interconnected computers of a product manufacturer and at least one buyer, wherein a process proceeded by the computer of product manufacturer having a database installed therein comprising the steps of estimating a quantity of repairable products, after receiving an estimated quantity of returned products from the computer of buyer, based on records of a returned ratio, a repaired ratio and an inventory of returned products stored in the database; combining the estimated quantity of repairable products with an estimated quantity of products regularly ordered by the buyer and an inventory of the products stored in the database to estimate a supply quantity of the products of a forthcoming period of time. This estimation of future supply is precise so that product manufacturer may arrange manufacturing processes based on the estimation for producing an ordered quantity of products in the forthcoming period of time prescribed by buyer. Moreover, the precise production can significantly reduce inventory and associated cost.

It is another object of the present invention to provide an inventory management system wherein a potential inconsistency between returned and repaired ratios and the actual ones is eliminated. In operation, the system can read parameters such as returned and repaired ratios from database and show the same on computer of product manufacturer when an estimated supply quantity of products of the forthcoming period of time is obtained. User may know the actual situation from the shown information prior to adjusting the parameters if an inconsistency exists. The adjusted parameters are substituted into the combination for estimating a supply quantity of products of the forthcoming period of time which is consistent with the actual one. As a result, the accuracy of estimating future supply by the system is greatly improved.

The above and other objects, features and advantages of the present invention will become apparent from the following detailed description taken with the accompanying drawings.

### BRIEF DESCRIPTION OF THE DRAWINGS

FIG. 1 schematically presents the connection of a product manufacturer and a buyer through a network connection according to the invention;

FIG. 2 is a flow chart illustrating a first preferred embodiment of inventory management system according to the invention;

FIG. 3 is a flow chart illustrating a second preferred embodiment of inventory management system according to the invention; and

FIG. 4 is a flow chart illustrating a third preferred embodiment of inventory management system according to the invention.

### DETAILED DESCRIPTION OF THE PREFERRED EMBODIMENTS

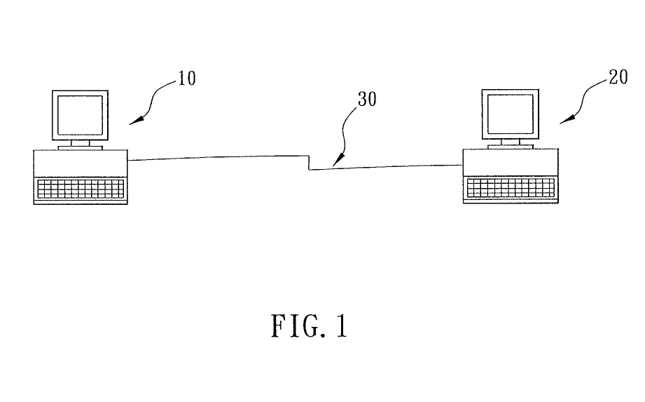

Referring to FIG. 1, there is shown a first embodiment of inventory management system in accordance with the invention. The system utilizes a network connection 30 for interconnecting computers of product manufacturer 10 and at least one buyer 20. Hence, computer of product manufacturer (called product manufacturer hereinafter) 10 may regularly receive orders from computer of buyer (called buyer hereinafter) 20. Once an order from buyer 20 is received by product manufacturer 10, product manufacturer 10 may store models and quantity of the ordered products in a database thereof. Then product manufacturer 10 may arrange manufacturing processes based on inventory of component parts. Hence, it is possible of producing the desired quantity of products in a forthcoming period of time prescribed by buyer 20. It is usual for buyer 20 to inform product manufacturer 10 about quantity of defected products after receiving the delivered products within a prescribed period of time. With such information, product manufacturer 10 may deliver the same quantity of products as the defected ones to buyer 20 in time.

The invention is directed to an inventory management system which is capable of combining the data of periodically returned products with the data stored in the database of the system and updating inventory of products accordingly. This can eliminate a potential inconsistency between actual inventory and shown inventory in database with respect to products. Such inconsistency as stated above can cause excessive inventory and increase associated cost. For achieving an object of eliminating the inconsistency, there is provided a mechanism in the system for estimating ratio of returned products with respect to delivered products (i.e., returned ratio) and ratio of repaired products with respect to returned products (i.e., repaired ratio) based on past records. Hence, product manufacturer 10 may input data about estimated quantity of repairable products into database immediately after knowing models and quantity of the same returned products received from buyer 20. It is understood that quantity of the reparable products is a product of all returned products multiplied by corresponding repaired ratio stored in the database. As such, product manufacturer 10 can estimate a supply quantity of the products of the forthcoming period of time by combining estimated quantity of reparable products with an inventory of the products stored in the database and an estimated quantity of products regularly ordered by buyer 20. This estimation of future supply is precise so that product manufacturer 10 may arrange manufacturing processes based on the estimation for producing an ordered quantity of products in a forthcoming period of time prescribed by buyer 20. This precise production can significantly reduce inventory and associated cost.

It is important to note that product manufacturer 10 needs to precisely estimate a supply quantity of products of the current month prior to arranging manufacturing processes accordingly. Product manufacturer 10 arrives at the supply quantity of products of the current month as follows:

Supply quantity of products of the current month=undelivered quantity of

products previously ordered by buyer 20+quantity of products ordered by

buyer 20 of the current month−estimated quantity of repairable products

provided by product manufacturer 10 (1)

, wherein the products are returned from the same buyer 20 (i.e., estimated quantity of repairable products). The estimated quantity of repairable products is a product of all returned products multiplied by the corresponding repaired ratio stored in database. Therefore, the supply quantity of products of the current month may be obtained by substituting the estimated quantity of repairable products into equation (1).

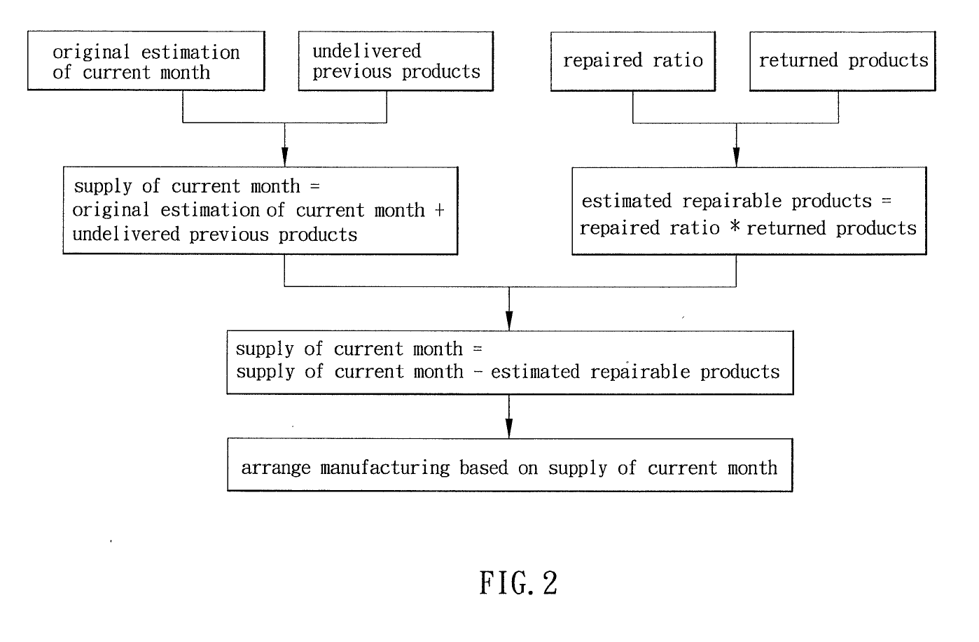

In a first embodiment of the invention as shown in FIG. 2, an inventory management system may regularly read data about undelivered quantity of products previously ordered by buyer 20, quantity of products ordered by buyer 20 of the current month, and returned products from database. Then estimated quantity of repairable products are obtained by multiplying all the returned products and the corresponding repaired ratio stored in database. Finally, a supply quantity of products of the current month is obtained by substituting the estimated quantity of repairable products into equation (1). With this information, product manufacturer 10 may arrange manufacturing processes by ordering component parts.

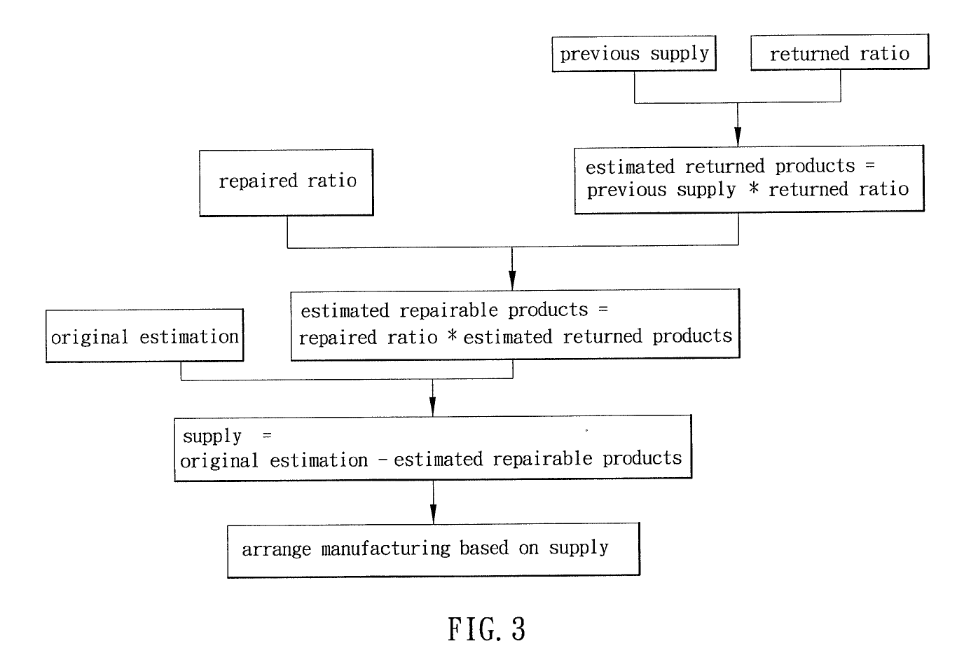

In a second embodiment of the invention as shown in FIG. 3, an inventory management system can estimate a supply quantity of products of a forthcoming month (i.e., future supply) based on relevant information stored in database. In estimation, the inventory management system may read data about quantity of ordered products of an immediate previous month of the forthcoming month and the corresponding repaired ratio from database. Hence, an estimated quantity of returned products of the forthcoming month is obtained. Then estimated quantity of repairable products of the forthcoming month are obtained by multiplying the estimated quantity of returned products and the corresponding repaired ratio stored in database. Finally, the future supply is obtained by substituting the estimated quantity of repairable products into equation (1). With this information, product manufacturer 10 may order component parts in advance for producing the ordered products of that forthcoming month. As an end, product manufacturer 10 may correctly arrange manufacturing processes, thus greatly reducing cost associated with excessive inventory.

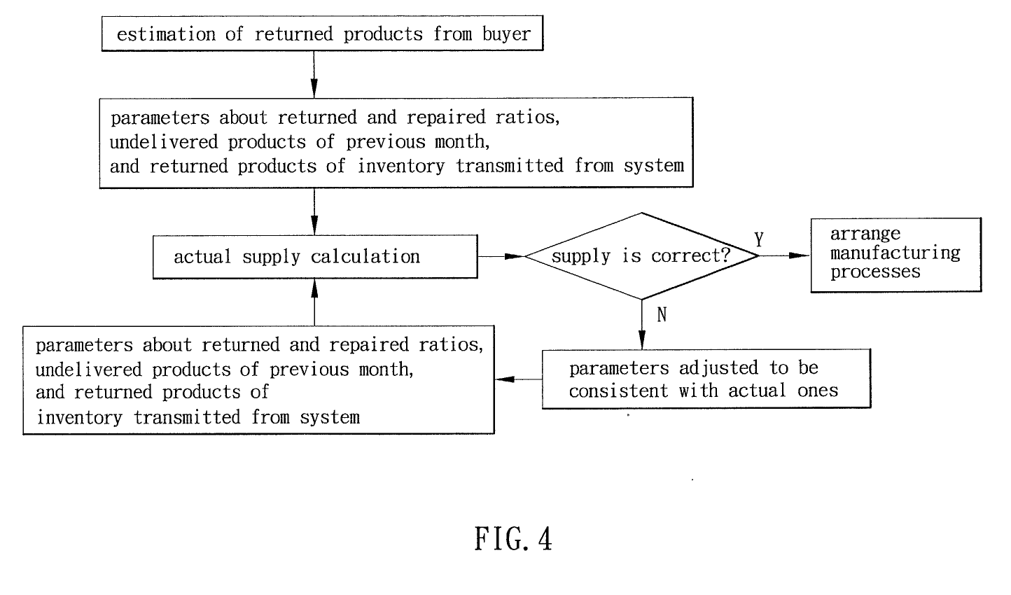

In a third embodiment of the invention as shown in FIG. 4, a potential inconsistency between returned and repaired ratios and the actual ones is eliminated. In detail, an inventory management system may read relevant parameters such as returned and repaired ratios from database and show the same on a screen of computer of product manufacturer 10 when an estimated supply quantity of products of the current or a forthcoming month is obtained, or the supply quantity of products of the current or a forthcoming month has been estimated. Administration employees may know the actual situation from the shown information accordingly prior to adjusting the parameters if an inconsistency exists. The adjusted parameters are substituted into equation (1) for estimating a supply quantity of products of the current or the forthcoming month which is consistent with the actual one. As a result, the accuracy of estimating future supply by the system is greatly improved.

In brief, inventory management system of the invention can significantly simplify a procedure of estimating supply quantity of products by product manufacturer and reduce time associated with the procedure. Also, a future supply of certain products may be precisely estimated. With this information, product manufacturer may correctly arrange manufacturing processes by ordering optimum quantity of component parts. As a result, an optimum quantity of products is produced, thus significantly reducing cost associated with excessive inventory.

While the invention has been described by means of specific embodiments, numerous modifications and variations could be made thereto by those skilled in the art without departing from the scope and spirit of the invention set forth in the claims.

What is claimed is:

1. An inventory management system having a network connection interconnected computers of a product manufacturer and at least one buyer, wherein a process proceeded by the computer of product manufacturer having a database installed therein comprising the steps of:
estimating a quantity of repairable products, after receiving an estimated quantity of returned products from the computer of buyer, based on records of a returned ratio, a repaired ratio and an inventory of returned products stored in the database;
combining the estimated quantity of repairable products with an estimated quantity of products regularly ordered by the buyer and an inventory of the products stored in the database to estimate a supply quantity of the products of a forthcoming period of time.

2. The process of claim 1, wherein the returned ratio is estimated based on records of returned products with respect to delivered products.

3. The process of claim 1, wherein the repaired ratio is estimated based on records of repaired products with respect to returned products.

4. The process of claim 1, wherein the supply quantity of the products of the forthcoming period of time comprises an undelivered quantity of the products previously ordered by the buyer, an quantity of the products estimated to be ordered by the buyer at the forthcoming period of time, and the estimated quantity of repairable products provided by the product manufacturer based on the products returned from the buyer.

5. The process of claim 4, wherein the quantity of the reparable products is the product of all the returned products multiplied by the corresponding repaired ratio stored in the database.

6. The process of claim 1, wherein the system is operable to read a quantity of the products estimated to be ordered by the buyer before the forthcoming period of time and the corresponding returned ratio from the database for estimating a quantity of the returned products of the forthcoming period of time.

7. The process of claim 6, wherein the system is operable to estimate a quantity of the repairable products of the forthcoming period of time by multiplying an estimated quantity of the returned products and the corresponding repaired ratio stored in the database.

8. The process of claim 7, wherein the system is operable to obtain the supply quantity of the products of the forthcoming period of time by substituting the estimated quantity of the repairable products into the combination.

9. The process of claim 1, wherein the system is operable to read parameters such as the returned and the repaired ratios from the database and show the same on the computer of the product manufacturer when an estimated supply quantity of the products of the forthcoming period of time is obtained, an user is visually aware of an actual situation from the shown information prior to adjusting the parameters if an inconsistency exists, and the adjusted parameters are substituted into the combination for estimating a supply quantity of products of the forthcoming period of time.
